(19) United States
(12) Patent Application Publication
(10) Pub. No.: US 2006/0003056 A1
(43) Pub. Date: Jan. 5, 2006

(54) Flexible packaging material with weakness line

(76) Inventor: Tonino Sandro D'Aversa, Toronto (CA)

Correspondence Address: SMITH, GAMBRELL & RUSSELL, LLP, 1850 M STREET, N.W., SUITE 800, WASHINGTON, DC, 20036, US

(21) Appl. No.: 11/157,168

(22) Filed: Jun. 21, 2005

Related U.S. Application Data
(60) Provisional application No. 60/582,428, filed on Jun. 25, 2004.

(51) Int. Cl. A23G 1/00

(52) U.S. Cl. 426/106

(57) ABSTRACT

A food packaging material suitable for food service applications, and the method in packaging and obtaining it. The packaging material is preferably formed from a flexible laminate sheet that includes at least one moisture impervious layer and has at least one weakness line, formed into a receptacle having a shape suitable for enclosing and packaging food sandwiches and like, which may be folded in such a manner to provide at least one flap and/or gusset. The method is such that food sandwiches and like are enclosed and packaged in such a manner as to prevent dripping or spilling of the content, while the assembled package can be opened and food product consumed without unfolding or unrolling the said package by simply tearing the provided weakness line for easy and safe food consumption.

### BACKGROUND OF THE INVENTION

This invention broadly relates to packaging materials, and more particularly, it concerns a moisture impervious packaging material with a weakness line, which may be folded in such a manner to provide at least one flap and/or gusset, especially useful for packaging food sandwiches and like and the method to package the said food product so as to prevent spillage and dripping of the said food product while easily consuming it in a clean, orderly and safe manner. In fact, the said package material may be torn with a single operation at the weakness line, so that the remaining portion of the packaging material continues acting as a package for the said food product and only the uncovered portion thereof is accessible for consumption. The remaining portion of the packaging material also acts like a pocket which enables the contents to be protected and drip proof, thereby avoiding any risk of soiling one's hands or clothing or contaminating the food contents of the package as well as scalding one's hand from direct contact with a hot food product.

Although this specification should be understood as requiring no restrictive limitations on the use of the disclosed packaging materials, materials produced according to the invention have been found to be particularly useful in the field of packaging materials for the retail sale of food products, particularly in the food service applications, such as sandwiches, burgers, pita wraps and like.

As is well known, as a consequence of established general practices, and in order to comply with the increasingly more restrictive and binding hygienically regulations, said food products offered for retail sale to the public are often packaged in wrappings consisting of a sheet of paper based material that is wrapped around food sandwiches and like.

Such wrappings, however, have several deficiencies. The subsequent assembled packaged must be unrolled, unfolded and/or disassembled in order to access the said food product and consume it. Consequently, the direct handling of the said food product may contaminated its integrity as well as allow for food spillage and dripping but more importantly, direct food contact with hot food sandwiches is an increased safety hazard.

### SUMMARY OF THE INVENTION

It is an object of this invention to improve food packaging materials and the manner in which food sandwiches are packaged, accessed and consumed and to provide a packaging material that is easy to manufacture, easy to store, and easy to apply, while at the same time, provide better performance and consumer convenience than that offered by conventional packaging, even the most recently developed.

This invention, therefore, relates to a packaging material particularly useful for wrapping said food products, which comprises of a flexible laminate sheet that includes at least one moisture impervious layer with at least one weakness line formed into a receptacle having a shape suitable for enclosing and packaging food sandwiches and like, which may be folded in such a manner to provide at least one flap and/or gusset, (and such may be welded or bonded at one or each perpendicular edge,) while the package is assembled by rolling and folding the packaging material.

Such rolling and folding enables that, once the said food product is placed onto to packaging material and positioned perpendicular to the weakness line, the package is rolled or folded or twisted in such a manner to prevent the dripping and spillage of the said food product.

The packaging material provides at least one weakness line, for instance a nearly central located longitudinal weakness line, so as to make it possible to remove a portion of the assembled package with a single tearing operation and to thereby uncover only a portion of the packaged food product, for instance a hot dog to be consumed, with no direct contact with the said food product, while the other half portion of the package is maintained in place as a protective cover for the food product and to avoid dripping or spillage of food content as well as scalding from hot food sandwiches. Of course, the longitudinal weakness line may be located at any place on the said packaging material. For instance, instead of centrally located, the weakness lines may be located at a laterally offset position.

The packaging material may include at least one air vent to allow hot air vapours to be released in order to prevent condensation and minimize possible bacteria growth within an assembled package.

The packaging material may include at least one transparent window to allow viewing of content of assembled package.

The packaging material may include at least one longitudinal and/or perpendicular pleat line or crease line, to indicate and facilitate the rolling, folding and/or packaging method. The said pleat line or crease line may be pre-folded in such a manner to provide at least one flap and/or gusset and such may be welded or bonded at one or each perpendicular edge.

The packaging material may include at least one perpendicular adhesive strip or adhesive sticker to ensure closure of the package assembly. Such adhesives and removable cover stripes are conventional and well known to those skilled in the adhesive arts.

Further details and advantages of this invention will be apparent from the following detailed description with reference to the annexed drawings in which the preferred embodiments are shown by way of illustration and not by way of limitation.

### DESCRIPTION OF THE DRAWINGS

FIG. 1 is a cross-sectional view of the packaging material according to this invention,

FIG. 2 is a perspective view of the packaging material according to this invention, whereby (1) is a flexible laminate sheet of food packaging material with at least one moisture impervious layer and (2) is a weakness line,

FIG. 3 shows a different embodiment of the invention having at least one vapour vent (3) to release air moisture and prevent condensation due to heat of food product. Such also limits bacterial growth within an assembled package. While, (8) is a transparent window to view assembled package content.

FIG. 4 shows a different embodiment of the invention having at least one longitudinal and/or perpendicular pleat line or crease line (4), as to indicate and facilitate the packaging method. The said pleat line or crease line may be folded in such a manner to provide at least one flap (9) and/or gusset (10) and such may be welded or bonded (11) at one or each perpendicular edge.

FIG. 5 shows a different embodiment of the invention having a perpendicular edge adhesive strip (6) or adhesive sticker (5) to keep package tightly wrapped or sealed,

FIG. 6 is a perspective view of the packaging material according to this invention with a food sandwich (7), in order to show how the said food product is positioned therein while it is being folded with the subsequent method to prevent spillage and/or dripping of contents. The folding mode is self-explaining, but it should be understood that the folding step can also be carried out as a rolling step and that the folding step can be also performed as twisting step, and that such folding or rolling step can also be performed in a different direction with respect to the illustrated one, without so departing from the scope of this invention,

FIG. 7. (A-E) shows the folding and rolling sequence subsequent to FIG. 6, in which the longitudinal sides are folded inwards onto the said food product and the package is rolled onto its self,

FIG. 8. (A-E) shows the folding and rolling sequence subsequent to FIG. 6, in which the packaging material is rolled onto the said food product and both longitudinal sides are folded inwards, and then package is rolled onto its self,

FIG. 9. (A-F) shows the folding and rolling sequence subsequent to FIG. 6, in which the packaging material is rolled onto the said food product and one longitudinal side is folded inwards, and then package is rolled onto its self and is finally assembled by twisting or folding over end,

FIG. 10. (A-E) shows the folding and rolling sequence subsequent to FIG. 6, in which the packaging material is rolled onto said food product and then rolled onto its self and is finally assembled by folding both longitudinal sides inwards,

FIG. 11. shows the folding and rolling sequence subsequent to FIG. 6, of the packaging material according to this invention which is folded in such a manner to provide at least one flap and/or gusset, in which food product is position under flap and/or in gusset and the packaging material is rolled onto said food product and then rolled onto its self and is finally assembled by folding or twisting open end,

FIG. 12.(A) shows the tearing and/or snapping of the packaging material in a single operation along the perforated weakness line with no direct contact with the packaged food product, while FIG. 11.(B) shows how the package is held by user in order to access and consume the said food product in a clean, orderly and safe manner,

FIG. 13 shows the packaging material adapted to tear along perforated weakness line with a single spiral operation and no direct contact with the packaged food product, in order to access and consume the said food product in a clean, orderly and safe manner,

FIG. 14 shows the packaging material adapted to provide two separate half portions with a single tearing or snapping operation,

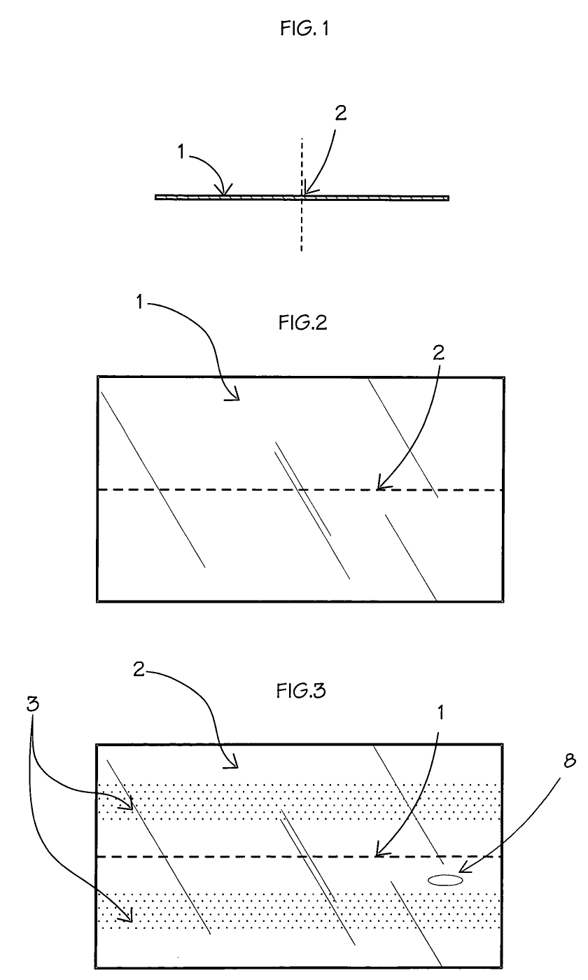

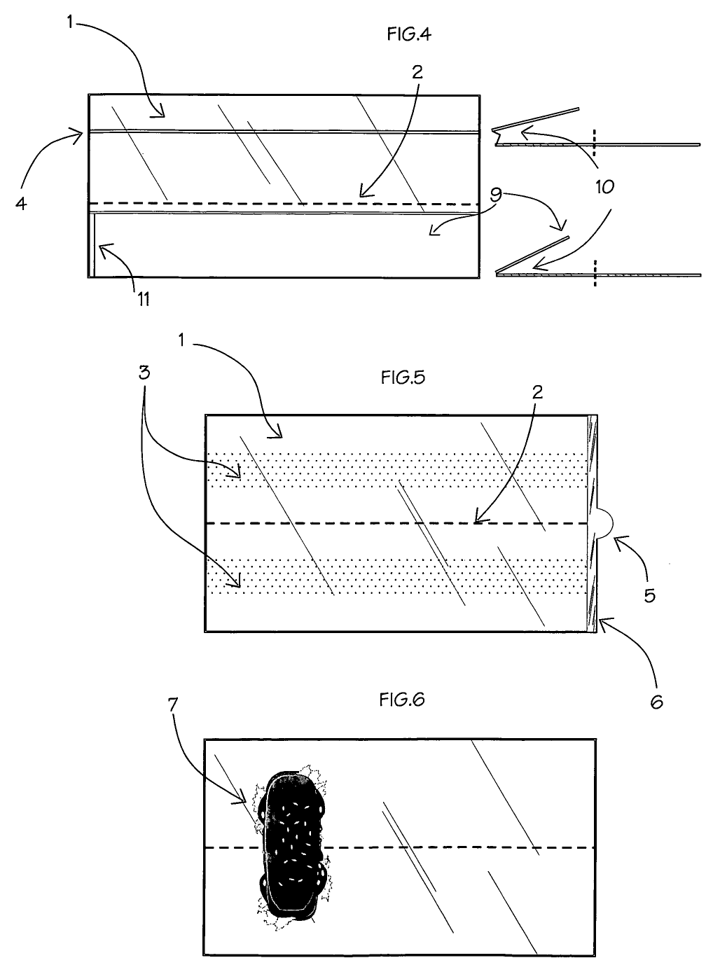

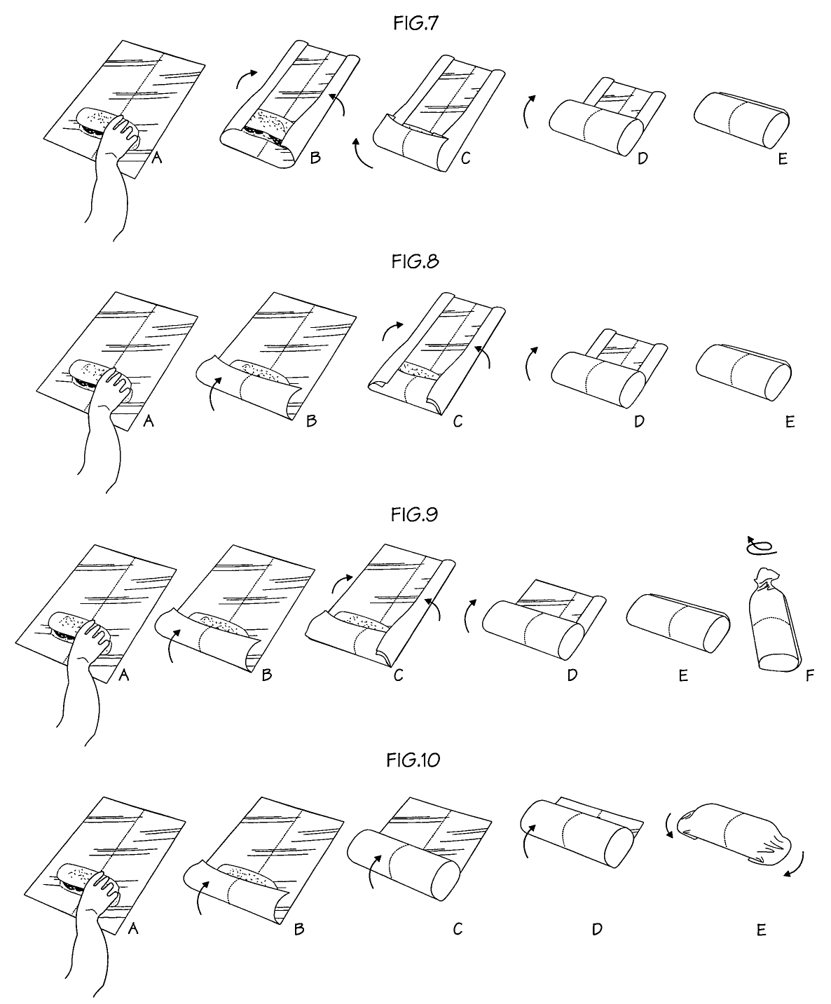

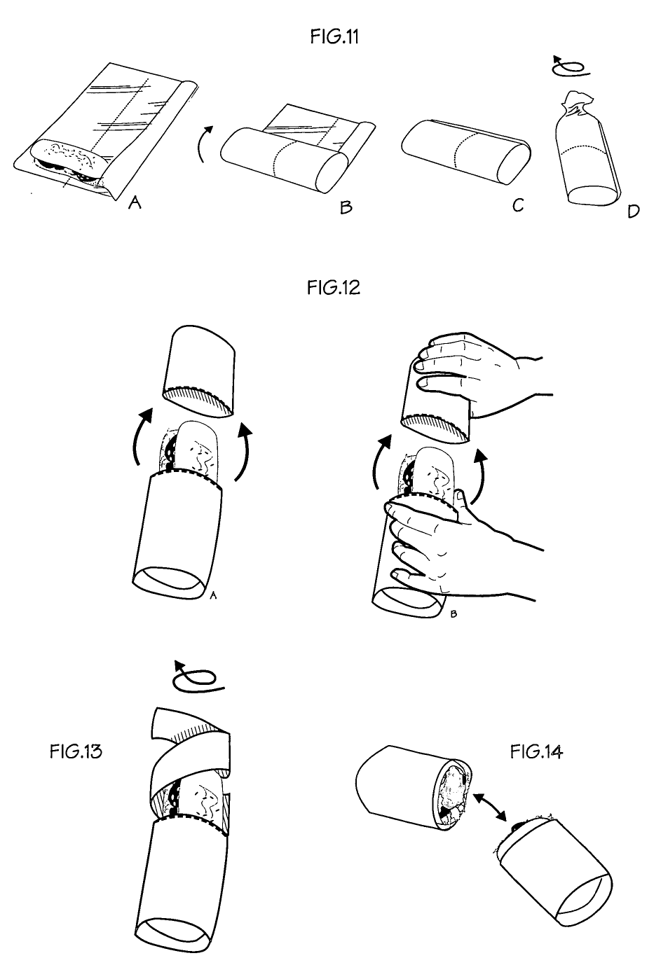

The preferred embodiments and packaging method of this invention have been heretofore described, but it should be expressly understood that those skilled in the art can make changes and modifications to the details and to the material compositions, as well as to the thickness and the shapes of the packaging materials, and packaging method, without departing from the spirit and scope of this invention as defined in the annexed claims.

What is claimed is:

1. A flexible laminate sheet food packaging material, comprising:
at least one moisture impervious layer, and
at least one weakness line that is perpendicular to a base of said food packaging material.

2. The packaging material according to claim 1, further comprising:
at least one air vapor vent to permit internal moisture to escape from said packaging material once assembled so as to prevent and limit condensation and bacterial growth within the said packaging material.

3. The packaging material according to claim 1, further comprising:
at least one transparent window to allow viewing of interior of said packaging material once assembled.

4. The packaging material according to claim 1, further comprising:
at least one glue strip or adhesive sticker for closing said package material.

5. The packaging material according to claim 4, wherein said glue strip comprises a pressure responsive adhesive optionally protected before use by a detachable cover strip.

6. The packaging material according to claim 1, further comprising:
at least one longitudinal and/or perpendicular pleat line or crease line so as to indicate and facilitate folding and rolling of said packaging material.

7. The packaging material according to claim 6, wherein said pleat line creates at least one flap and/or gusset which is optionally welded at one or each perpendicular edge.

8. A method for enclosing and packaging a food product, so as to prevent and/or minimize dripping, dropping and spilling said product, comprising:
placing at least one food product on the pakaging material of claim 1; and
enclosing said food product within said packaging material by folding said packaging material around said food product so that said packaging material surrounds and encloses said food product.

9. The method according to claim 8, wherein
said food product is positioned perpendicular to the weakness line, and
said packaging material is enclosed by folding both longitudinal sides of said packaging material inwards onto said food product and then by rolling said packaging material over said food product and onto itself.

10. The method according to claim 8, wherein
said food product is positioned perpendicular to the weakness line, and
said packaging material is enclosed by rolling a packaging material end over said food product and then folding both longitudinal sides inwards onto said food product and onto itself.

11. The method according to claim 8, wherein
said food product is positioned perpendicular to the weakness line, and
said food packaging material is enclosed by rolling a packaging material end over said food product, then by folding one longitudinal side inwards onto said food product thereby rolling the entire package onto itself, and then by twisting or folding over a resulting end.

12. The method according to claim 8, wherein
said food product is positioned perpendicular to the weakness line, and
said packaging material is enclosed by rolling said packaging material over said food product, then by rolling said packaging material onto itself, and then by folding inwards both longitudinal sides.

13. The method according to claim 8, wherein
said packaging material further comprises at least one folded flap and/or gusset, and wherein
said food product is positioned perpendicular to the weakness line and under the folded flap and/or in gusset, and
said packaging material is enclosed by rolling said packaging material over said food product, then by rolling said packaging material onto itself, and then by twisting and/or folding over a resulting end.
